(19) United States
(12) Patent Application Publication
(10) Pub. No.: US 2007/0147682 A1
(43) Pub. Date: Jun. 28, 2007

(54) System and Method For Feature Detection In Image Sequences

(75) Inventors: Ti-chiun Chang, Plainsboro, NJ (US); Tong Fang, Morganville, NJ (US); Jason Jenn-Kwei Tyan, Princeton, NJ (US); Yunqiang Chen, Plainsboro, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS CORPORATE RESEARCH, INC., PRINCETON, NJ (US)

(21) Appl. No.: 11/566,353

(22) Filed: Dec. 4, 2006

Related U.S. Application Data
(60) Provisional application No. 60/742,989, filed on Dec. 7, 2005.

(51) Int. Cl. G06K 9/46

(52) U.S. Cl. 382/190

(57) ABSTRACT

A method for processing image data includes inputting image data, determining a plurality of quadrature filter pairs based on filter parameter values to detect features of interest in the image data, applying the quadrature filter pairs to the image data to obtain a set of filter responses, and processing the filter responses to obtain the features of interest in the image data.

### CROSS-REFERENCE TO RELATED PATENT APPLICATION

This application claims the benefit of U.S. Provisional Application Ser. No. 60/742,989 (Attorney Docket No. 2005P22360US), filed Dec. 7, 2005 and entitled “Efficient line and curve detection in noisy images with application to X-ray fluoroscopy,” the content of which is herein incorporated by reference in its entirety.

### BACKGROUND OF THE INVENTION

1. Technical Field

The present disclosure relates to image analysis and, more particularly, to systems and methods for feature detection in image sequences.

2. Discussion of Related Art

Edges, lines, and curves, collectively referred to as features, are among the fundamental visual cues in low-level vision processes. Feature detection has been a core topic in the computer vision community for several decades. There exists a need for an efficient system and method for providing accurate detection of features while minimizing false detection.

In applications of real-time medical imaging, it is of particular interest to detect and track guidewires and catheters, which typically appear as noisy curves. Due to the strong interference noise in medical imagery, most conventional feature detection techniques do not achieve satisfactory results.

In recent years, great effort has been devoted to the challenges to designing efficient and effective methods of feature detection. The gradient-based methods have received the most attention in the literature. The basic idea of these methods is to develop derivative operators for the image function. Recently, phase-based methods have emerged as good alternatives, largely because they are invariant to different lighting/viewing conditions and show good correspondence to human visual processing. Phase-based methods rely on local frequency analysis Quadrature filter pairs have been designed and applied to generate local phases. A pair of filters are said to be in quadrature if they have the same frequency response but differ in phase by 90°.

The features of interest in an application may have similar forms. For example, in medical imaging applications the features of interest often have similar forms. Existing feature detection solutions are aimed at processing general images having features that can take on a variety of forms and scales. These feature detection methods are either unsuitable or overly complex for many applications.

### SUMMARY OF THE INVENTION

According to an exemplary embodiment of the present invention, a 20 method for processing image data includes inputting image data. determining a plurality of quadrature filter pairs based on filter parameter values to detect features of interest in the image data, applying the quadrature filter pairs to the image data to obtain a set of filter responses, and processing the filter responses to obtain the features of interest in the image data.

According to an exemplary embodiment of the present invention, an image data processing system comprises a memory device for storing a program, a processor in communication with the memory device, the processor operative with the program to input image data, determine a plurality of quadrature filter pairs based on the values of filter parameters to detect features of interest in the image data, apply the quadrature filter pairs to the image data to obtain a filter response for each of the quadrature filter pairs, and process the filter response to obtain the features of interest in the image data.

According to an exemplary embodiment of the present invention a computer-implemented method for detecting features in image data includes inputting image data, determining a plurality of quadrature filter pairs based on filter parameter values to detect features of interest in the image data, applying the quadrature filter pairs to the image data to obtain a filter response for each of the quadrature filter pairs, offsetting each filter response by a predetermined value, applying soft thresholding to each filter response to obtain thresholded outputs, summing the filter responses over different orientations, and normalizing a summation of the thresholded outputs using a summation of a magnitude of the filter response for each of the quadrature filter pairs.

### BRIEF DESCRIPTION OF THE DRAWINGS

The present invention will become more apparent to those of ordinary skill in the art when descriptions of exemplary embodiments thereof are read with reference to the accompanying drawings.

FIGS. 1A, 1B and 1C illustrate examples of a spatially oriented quadrature filter pair, according to exemplary embodiments of the present invention.

FIG. 2 is a flowchart showing a method of extracting features of interest in image data, according to an exemplary embodiment of the present invention.

FIG. 3 shows an example of X-ray image data containing a noisy guidewire.

FIG. 4 shows a feature detection result in the X-ray image data of FIG. 3, according to an exemplary embodiment of the present invention.

FIG. 5 shows an example of X-ray image data containing a noisy catheter.

FIG. 6 shows a feature detection result in the X-ray image data of FIG. 5, according to an exemplary embodiment of the present invention.

FIG. 7 is a flowchart showing a method of detecting features in image data, according to an exemplary embodiment of the present invention.

FIG. 8 illustrates a computer system for implementing a method of detecting features in image data, according to an exemplary embodiment of the present invention.

FIG. 9 is a flowchart showing a computer-implemented method of detecting features in image data, according to an exemplary embodiment of the present invention.

### DESCRIPTION OF EXEMPLARY EMBODIMENTS

Hereinafter, exemplary embodiments of the present invention will be described in detail with reference to the accompanying drawings.

A method of detecting features in image data, according to an exemplary embodiment of the present invention, uses a directional bandpass filter to enhance a feature of interest. The image data may be medical image data or other image data. An image may comprise two-dimensional image data, three-dimensional image data and/or higher-dimensional image data.

In an exemplary embodiment of the present invention, the log-Gabor function is used to specify the frequency response of the desired bandpass filter, On the linear frequency scale the log-Gabor function has a transfer function of the form.
G₁(w)=e^{-log(|w|/w}^{₀}⁾^{²}^{/2log(σ}^{_{w}}^{/w}^{₀}⁾^{²}, (1)
where w is the spatial frequency, with |w|=\sqrt{wₓ²+w_{y}²}; w₀ is the filter's center frequency; and σ_{w} controls the radial bandwidth.

The log-Gabor function may be multiplied with a directional selection function to obtain oriented bandpass filters of the form:
Dᵢ(w,θ)=G₁(w)e^{-(θ-θ}^{ᵢ}⁾^{²}^{/2σ}^{_{θ}}^{²}, (2)
where σ_{θ} controls the roll-off slope (angular bandwidth) in the support of the angular dimension; θ=arc tan(w_{y}/wₓ) is the orientation of each frequency grid; and θᵢ, i=0, 1, . . . d is the specified orientation. In the frequency domain, the filters have non-zero magnitude only on one side of the frequency plane. In the image domain, the filters are complex-valued and are quadrature filters, with the real and imaginary part, respectively, corresponding to a ridge and an edge detection mask.

The filter parameters w₀, σ_{w} and σ_{θ}, used in Equations 1 and 2, are selected to detect the feature of interest while minimizing the false detection for a given application. In an exemplary embodiment of the present invention, a training procedure is designed to determine the values of the filter parameters. For example, a training procedure is designed in which the features of interest in one or more of images f(x,y) are manually extracted and binarized, and then serve as a groundtruth, which can be expressed as follows:

$$g ( x , y ) = \{ \begin{matrix}1 , & if f ( x , y ) ∈ features of interest \\ 0 , & otherwise .\end{matrix} \qquad ( 3 )$$

Using a downhill search algorithm, several possible values of the filter parameters are tested to process the image f(x,y). For example, three or four possible values of the filter parameters may be tested. It is to be understood that the number of possible values of the filter parameters that are to be tested to process the image f(x,y) may depend on application needs, computational facility, etc.

The results are compared to the groundtruth based on a given criterion. In an exemplary embodiment of the present invention, the sum of a magnitude of the filter response of each quadrature filter pair is binarized to form fᵣ, and the Hamming distance Dₕ(fᵣ, g) is computed, for example, using Equation 4.

$${D}_{h} ( {f}_{r} , g ) = {\sum }_{x , y} \vert {f}_{r} ( x , y ) - g ( x , y ) \vert \qquad ( 4 )$$

The filter parameters that result in the best match, for example, the minimum Hamming distance, are the desirable values that can be used for a designated application.

In an exemplary embodiment of the present invention, “optimal” values for the fitter parameters W₀, σ_{w} and σ_{θ} can be empirically determined by observing the filter responses of different filters. This decision may be application dependent. The contributions from the real and imaginary parts of the filters may be weighted depending on the feature type. For instance, if only line features are of interest, the imaginary part of the filters can be ignored.

After the frequency response is specified, the filter coefficients are derived in the image domain. Given that the targeted filters are discrete, the oriented log-Gabor function can be sampled with a W_{f}×W_{f} window to obtain the discrete oriented log-Gabor function D_{di}(u,v), where i=0, 1, . . . , d. In an exemplary embodiment of the present invention, a spatial filter of size w×w is optimized in the sense that its Fourier transform, sampled at the same size W_{f}×W_{f} and compared with D_{di}(u,v), has the minimum mean squared error. For example, an optimized filter kernel h*ⱼ can be obtained using Equation 5,

$${h}_{i}^{*} ⌈ m , n ⌉ = arg {min}_{{h}_{i} ( m , n )} α ( u , v ) {\vert {D}_{di} ( u , v ) - {F}_{{W}_{f}} ( {h}_{i} ( m , n ) ) \vert}^{2} , \qquad ( 5 )$$

where F_{w}_{_{f}} denotes the Fourier transform sampled with the size W_{f}×W_{f}; and α(u,v) is the weighting function for different position in the frequency plane, A Gaussian function with strong weighting at the direct current (DC) can be used.

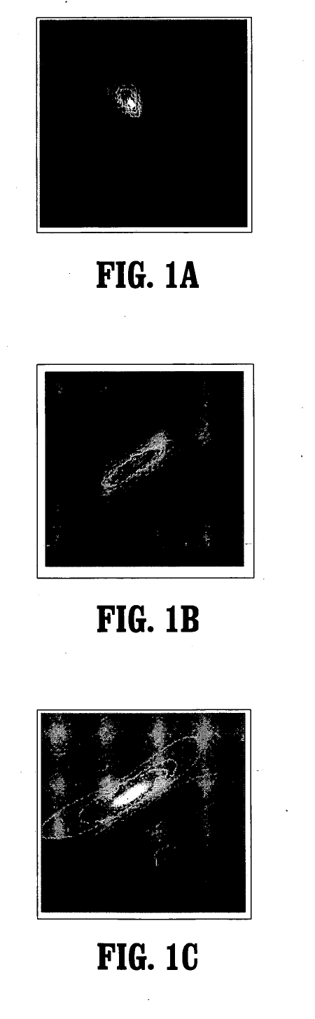

A closed-form solution of Equation 5 can be obtained by taking the derivative of the objective functional with respect to each variable in hᵢ(m,n), setting it to zero, and solving for the system of linear equations. FIGS. 1A, 1B and 1C illustrate examples of a spatially oriented quadrature filter pair, according to an exemplary embodiment of the present invention.

FIG. 1A shows the frequency response (frequency domain), and FIGS. 1B and 1C, respectively, show the real and imaginary pars of the quadrature filter. The quadrature filter pairs shown in FIGS. 1B and 1C are oriented at 30° in the image domain. Similar kernels for different orientations can be obtained.

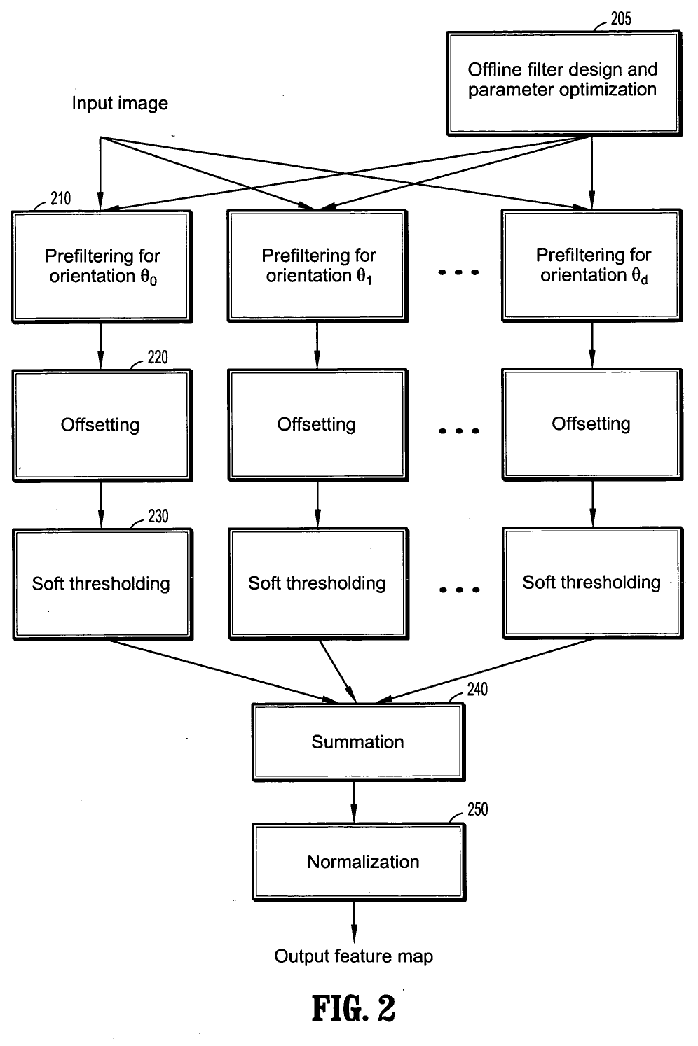

The optimized oriented quadrature filters are applied to the input image for feature detection, according to an exemplary embodiment of the present invention. Hereinafter, a method of extracting the features of interest will be described with reference to FIG. 2.

FIG. 2 is a flowchart showing a method of extracting features of interest in image data, according to an exemplary embodiment of the present invention, The features of interest may comprise cured shapes, such as for example, a guidewire or a catheter. Features of interest may comprise, lines, curved shapes, or step edges.

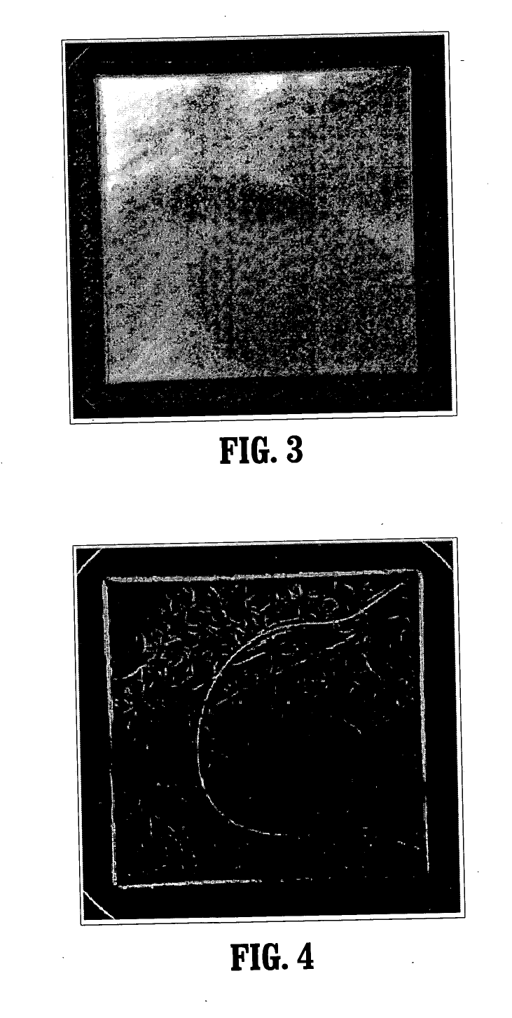

FIG. 3 shows an example of X-ray image data containing a noisy guidewire. The thin curved guidewire shown in FIG. 3 is difficult to discern.

FIG. 4 shows a feature detection result in the X-ray image data of FIG. 3, according to an exemplary embodiment of the present invention. The thin curved guidewire is readily discernable in FIG. 4,

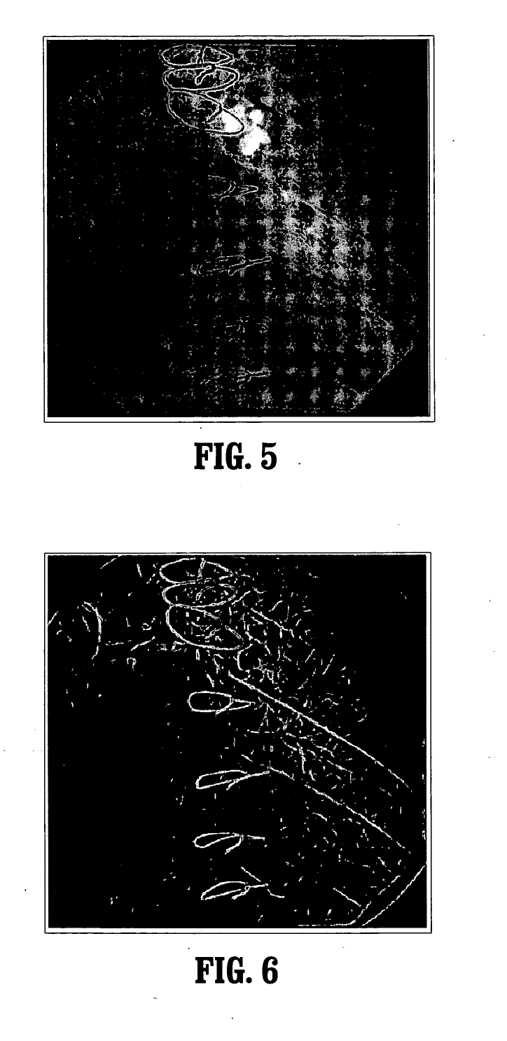

FIG. 5 shows an example of X-ray image data containing a noisy catheter. FIG. 6 shows a feature detection result in the X-ray image data of FIG. 5, according to an exemplary embodiment of the present invention. The catheter is readily discernable in FIG. 6.

Referring to FIG. 2, in block 205, perform filter design and parameter optimization. For example, determine a parameter set which minimizes the Hamming distance between the processed output and the binarized groundtruth.

In block 210, the input image is convolved with each oriented log-Gabor filter D_{di} to create a filter response fᵣᵢ. Using these filter responses fᵣᵢ, where i=0, 1, . . . , d, the features of interest can be extracted, according to an exemplary embodiment of the present invention using a process as follows.

Each filter response fᵣᵢ is first offset by a predetermined constant s, in block 220. The constant s is application dependent. For example, in a case when the features of interest have lower intensities than the background, s is negative. When the features of interest have higher intensities than the background, s is positive. In the case when there is no preference over dark/bright features, s is set to 0. For notational simplicity, \tilde{f}ᵣᵢ=fᵣᵢ+s is used herein to represent the offset filter response.

According to an exemplary embodiment of the present invention, only the real part of the complex filter is used when only ridges are of particular interest. Only the imaginary part of the complex filter may be used when only step edges are of particular interest. For example, in the case of enhancing guidewires and catheters in X-ray fluoroscopy, which appear as dark and noisy curves, only the real part of the complex filter may be used.

The block 230 is soft thresholding of |\tilde{f}ᵣᵢ|, which can be expressed as Equation 6.
f̅ᵣᵢ32 max(|f\tilde{f}|ᵣᵢ−T,0) (6)
where T is a threshold estimated from noise statistics. Threshold estimation from noise characteristics will be discussed later in this disclosure. In an exemplary embodiment of the present invention, soft thresholding is used to enhance features of interest while mitigating noise in the filter response fᵣᵢ.

In block 240, sum over \tilde{f}ᵣᵢ to integrate information for all of the oriented filter responses, as can be expressed by Equation 7.

$${\overline{f}}_{r} = {\sum }_{i = 0}^{d} {\overline{f}}_{ri} \qquad ( 7 )$$

In block 250, normalize f̅ᵣ to obtain the desired feature map, as can be expressed by Equation 8.

$${f}_{f} = {\overline{f}}_{r} / {\sum }_{i = 0}^{d} \vert {f}_{ri} \vert \qquad ( 8 )$$

In cases when a binary feature map is desired, after block 250, a simple global threshold can be applied.

In general, noise has a flat uniform spectrum across all frequency regions. In contrast, a general image has its spectrum concentrating on the low frequency region, although some important Image structures also spread its energy in the high frequency region. In an exemplary embodiment of the present invention, the noise statistics are estimated from subband images revealing high frequency characteristics.

The threshold T, according to an exemplary embodiment of the present invention, is estimated using the magnitude histogram Hᵢ(|fᵣᵢ|) of each filter response fᵣᵢ. In general, since noise is everywhere in the image and there are only few structures of interest, a percentile p of the histogram is due to noise, where p is close to 1. According to an exemplary embodiment of the present invention, a good estimate of T is obtained using Equation 9.

$$p \approx {\sum }_{k = {f}_{min}}^{T} {H}_{i} ( k ) / {\sum }_{k = {f}_{min}}^{{f}_{max}} {H}_{i} ( k ) , \qquad ( 9 )$$

where fₘᵢₙ=min(|fᵣᵢ(m,n)|) and fₘₐₓ=max(|fᵣᵢ(m,n)|) are respectively the minimum and maximum of the histogram. The threshold T can be found by searching the histogram.

In applications in which speed performance needs to be optimized, forming a histogram for each filter response at different orientation may not be affordable. In an exemplary embodiment of the present invention, estimating T includes designing a lowpass Gaussian filter, and subtracting the Gaussian filtered result from the input image. Again, this residual image g mostly corresponds to the noise components. The histogram Hᵢ(|g|) can then be formed. Assuming that the summation from 0 to c when passing the predetermined percentile p_{G} of the histogram is due to noise, c can provide a good estimate for the noise threshold T in Equation 6. It will be appreciated that the values of p and p_{G} may be different from each other, for example, due to a difference in filter energy. The threshold T may be efficiently estimated from noise statistics.

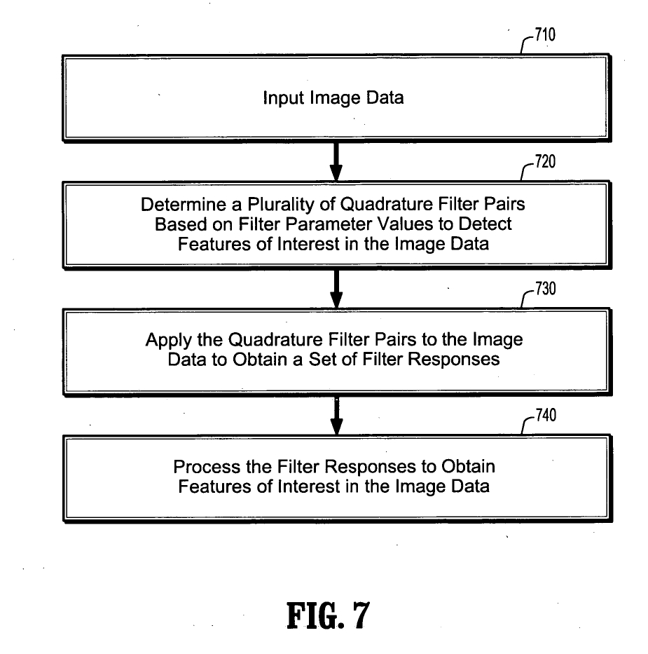

FIG. 7 is a flowchart showing a method of detecting features in image data, according to an exemplary embodiment of the present invention. Referring to FIG. 2, in block 710, input image data. For example, the image data may be medical image data.

In block 720, determine a plurality of quadrature filter pairs based on filter parameter values to detect features of interest in the image data. A log-Gabor function may be used to specify a frequency response of the quadrature filter pairs. The values for the filter parameters may be obtained using extracted and binarized features of interest that serve as a groundtruth. A plurality of the filter parameters may be tested using a downhill search algorithm to determine a parameter set that can generate results most close to the groundtruth.

In block 730, apply the quadrature filter pairs to the image data to obtain a set of filter responses.

In block 740, process the filter responses to obtain features of interest in the image data. For example, processing the filter responses for each of the quadrature filter pairs may include performing an application-specific non-linear operation for each filter response, and generating illumination and contrast invariant measures after integrating and scaling the filter responses over different orientations.

Performing the application-specific non-linear operation may include estimating a threshold using a magnitude histogram of each filter response. Scaling the filter responses over different orientations may include normalizing a summation of thresholded outputs using a summation of a magnitude of the filter response for each of the quadrature filter pairs.

The features of interest in the image data may be displayed on a display device or saved to a random access memory (RAM), read only memory (ROM), disk drive, tape drive, etc., or a combination thereof.

It is to be understood that exemplary embodiments of the present invention may be implemented in various forms of hardware, software, firmware, special purpose processors, or a combination thereof. For example, exemplary embodiments of the present invention may be implemented in software as an application program tangibly embodied on a program storage device. The application program may be uploaded to, and executed by, a machine comprising any suitable architecture.

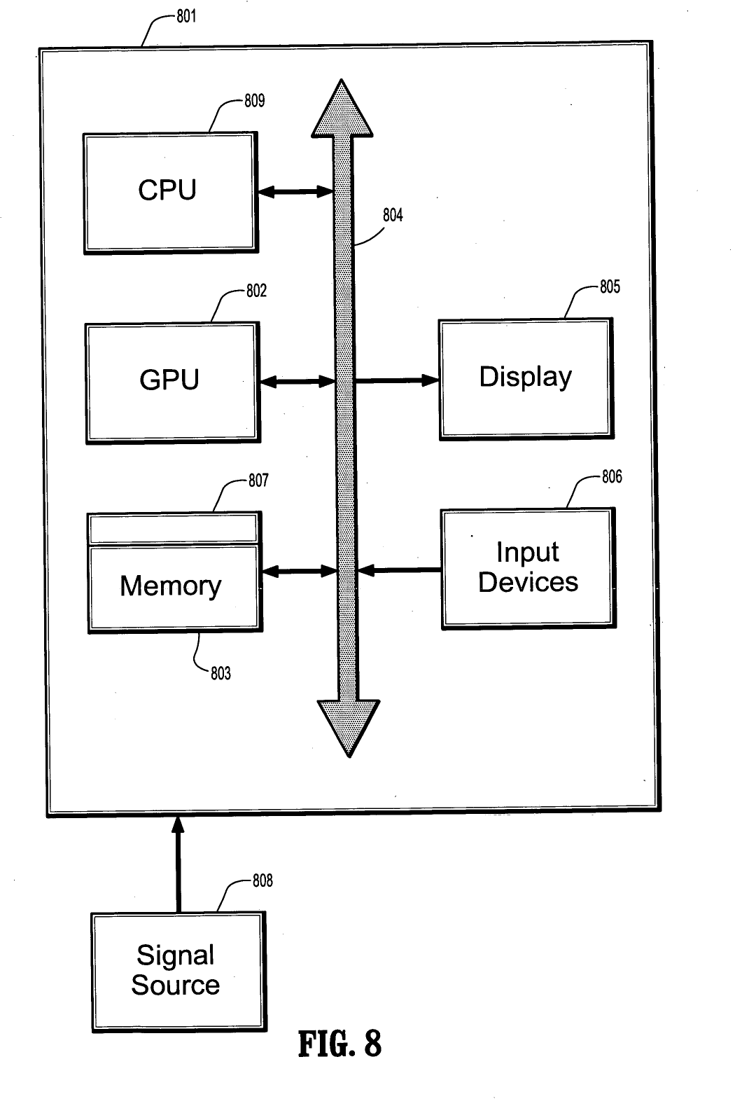

Referring to FIG. 8, according to an exemplary embodiment of the present disclosure, a computer system 801 for implementing a method of detecting features in image data can comprise, inter alia, a central processing unit (CPU) 809, a memory 803 and an input/output (I/O) interface 804. The computer system 801 may include a graphics processing unit (CPU) 802. The computer system 801 is generally coupled through the I/O interface 804 to a display 805 and various input devices 806 such as a mouse and keyboard. The support circuits can include circuits such as cache, power supplies, clock circuits, and a communications bus. The memory 803 can include random access memory (RAM) read only memory (ROM), disk drive, tape drive, etc., or a combination thereof. An exemplary embodiment of the present invention can be implemented as a routine 807 that is stored in memory 803 and executed by the CPU 809 to process the signal from the signal source 808. As such, the computer system 801 is a general purpose computer system that becomes a specific purpose computer system when executing the routine 807 of the present invention,

The computer platform 801 also includes an operating system and micro instruction code. The various processes and functions described herein may either be part of the micro instruction code or par of the application program (or a combination thereof) which is executed via the operating system. In addition, various other peripheral devices may be connected to the computer platform such as an additional data storage device and a printing device.

In an exemplary embodiment of the present invention, image data processing system comprises a memory device 803 for storing a program, and a processor 809 in communication with the memory device 803. The processor 809 is operative with the program to input image data, determine a plurality of quadrature filter pairs based on the values of filter parameters to detect features of interest in the image data, apply the quadrature filter pairs to the image data to obtain a filter response for each of the quadrature filter pairs, and process the filter response to obtain features of interest in the image data, A log-Gabor function may be used to specify a frequency response of the quadrature filter pairs.

When processing the filter responses the processor may be further operative with the program to perform an application-specific non-linear operation for each filter response, and generating illumination and contrast invariant measures after integrating and scaling the filter responses over different orientations. When performing the application-specific non-linear operation, the processor may be further operative with the program to estimate a threshold using the magnitude histogram of each filter response. When scaling the filter responses over different orientations the processor may be further operative with the program to normalize a summation of thresholded outputs using a summation of a magnitude of the filter response for each of the quadrature filter pairs.

It is to be further understood that, because some of the constituent system components and methods depicted in the accompanying figures may be implemented in software, the actual connections between the system components (or the process) may differ depending upon the manner in which the present invention is programmed. Given the teachings of exemplary embodiments of the present invention provided herein, one of ordinary skill in the related an will be able to contemplate these and similar implementations or configurations of the present invention.

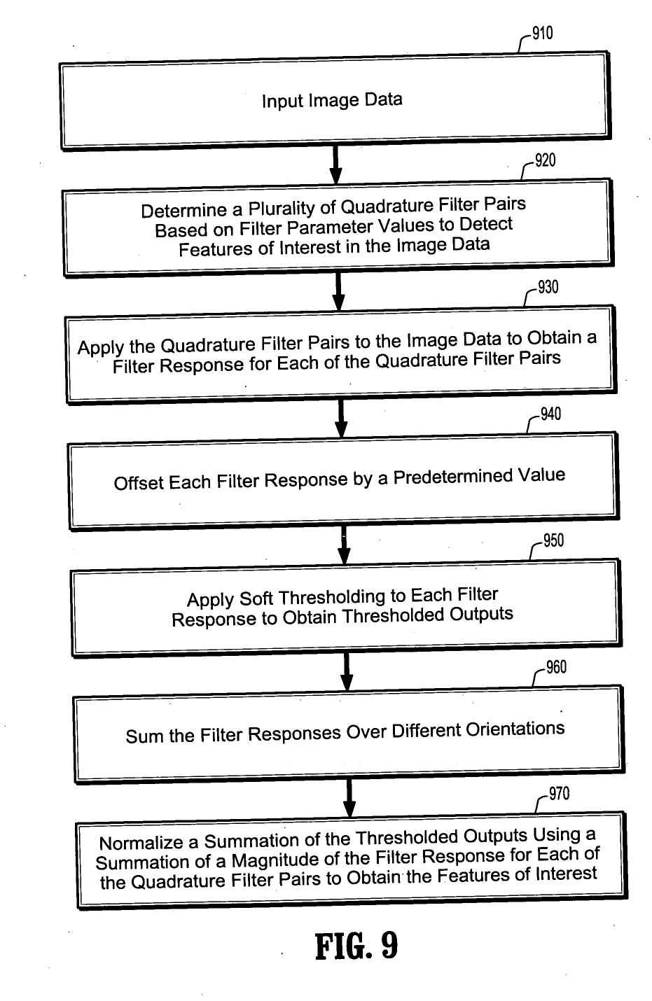

FIG. 9 is a flowchart showing a computer-implemented method of detecting features in image data, according to an exemplary embodiment of the present invention.

Referring to FIG. 9, in block 910, input image data. The image data may be medical image data.

In block 920, determine a plurality of quadrature filter pairs based on filter parameter values to detect features of interest in the image data. A log-Gabor function may be used to specify a frequency response of the quadrature filter pairs. The values for the filter parameters may be obtained using extracted and binarized features of interest that serve as a groundtruth. A plurality of the filter parameters may be tested using a downhill search algorithm to determine a parameter set that can generate results most close to the groundtruth.

In block 930, apply the quadrature filter pairs to the image data to obtain a filter response for each of the quadrature filter pairs. For example, applying the quadrature filter pairs may comprise convolving the image data with the filters.

In block 940, offset each filter response by a predetermined value. The predetermined value may be a negative number, a positive number, or zero based on application specific characteristics. For example, when the features of interest have lower intensities than a background, the predetermined value may be a negative number. When the features of interest have higher intensities than a background, the predetermined value may a positive number. When there is no preference over dark features or bright features, the predetermined value may be zero.

In block 950, apply soft thresholding to each filter response to obtain thresholded outputs. Soft thresholding may include estimation of noise characteristics using a high frequency component of the image.

In block 960, sum the filter responses over different orientations. For example, if six quadrature filter pairs are designed for a two-dimensional image, the results from block 950 are summed for the six filter pairs.

In block 970, normalize a summation of the thresholded outputs using a summation of a magnitude of the filter response for each of the quadrature filter pairs to obtain the features of interest in the image data. In an exemplary embodiment of the present invention. Equation 8 is used to normalize the summation of the thresholded outputs. The features of interest may be displayed on a display device or saved to a random access memory (RAM), read only memory (ROM), disk drive, tape drive, etc., or a combination thereof.

A method of efficient feature detection, according to an exemplary embodiment of the present invention, extracts corrupted curves in noisy images. A method of efficient feature detection, according to an exemplary embodiment of the present invention, employs an optimal directional filter design and a post processing procedure to detect curvy structures. To estimate a threshold parameter in post processing, an effective noise model is used. A method of efficient feature detection, according to an exemplary embodiment of the present invention, may be used for adaptive filtering and guidewire tracking. In a multi-resolution framework, according to an exemplary embodiment of the present invention, each individual resolution is treated as a new application and the process of designing optimal prefilters, adjusting post processing, and estimating noise statistics are repeated for each individual resolution.

Although exemplary embodiments of the present invention have been described in detail with reference to the accompanying drawings for the purpose of illustration, it is to be understood that the inventive processes and systems are not to be construed as limited thereby. It will be readily apparent to one of ordinary skill in the an that various modifications to the foregoing exemplary embodiments can be made without departing from the scope of the invention.

What is claimed is:

1. A method for processing image data, comprising:
inputting image data;
determining a plurality of quadrature filter pairs based on fitter parameter values to detect features of interest in the image data;
applying the quadrature filter pairs to the image data to obtain a set of filter responses; and
processing the filter responses to obtain the features of interest in the image data.

2. The method of claim 1, wherein a log-Gabor function is used to specify a frequency response of the quadrature filter pairs.

3. The method of claim 1, further comprising determining the filter parameters values using binarized features of interest that serve as a groundtruth.

4. The method of claim 3, wherein a plurality of the filter parameters are tested using a downhill search algorithm to determine a parameter set that can generate results close to the groundtruth.

5. The method of claim 1, wherein processing the filter responses for each of the quadrature filter pairs comprises:
performing an application-specific non-linear operation for each filter response; and
generating illumination and contrast invariant measures after integrating and scaling the filter responses over different orientations.

6. The method of claim 5, wherein performing the application-specific non-linear operation includes estimating a threshold using a magnitude histogram of each filter response.

7. The method of claim 5, wherein scaling the filter responses over different orientations comprises normalizing a summation of thresholded outputs using a summation of a magnitude of the filter response for each of the quadrature filter pairs.

8. An image data processing system, comprising:
a memory device for storing a program;
a processor in communication with the memory device, the processor operative with the program to:
input image data;
determine a plurality of quadrature filter pairs based on the values of filter parameters to detect features of interest in the image data;
apply the quadrature filter pairs to the image data to obtain a filter response for each of the quadrature filter pairs; and
process the filter responses to obtain the features of interest in the image data.

9. The image data processing system of claim 8, wherein a log-Gabor function is used to specify a frequency response of the quadrature filter pairs.

10. The image data processing system of claim 8, wherein when processing the filter responses, the processor is further operative with the program to:
perform an application-specific non-linear operation for each filter response; and
generating illumination and contrast invariant measures after integrating and scaling the filter responses over different orientations.

11. The image data processing system of claim 10, wherein when performing the application-specific non-linear operation, the processor is further operative with the program to estimate a threshold using a magnitude histogram of each filter response.

12. The image data processing system of claim 10, wherein when scaling the filter responses over different orientations the processor is further operative with the program to normalize a summation of thresholded outputs using a summation of a magnitude of the filter response for each of the quadrature filter pairs.

13. A computer-implemented method of detecting features in image data, comprising:
inputting image data;
determining a plurality of quadrature filter pairs based on filter parameters values to detect features of interest in the image data;
applying the quadrature filter pairs to the image data to obtain a filter response for each of the quadrature filter pairs;
offsetting each filter response by a predetermined value;
applying soft thresholding to each filter response to obtain thresholded outputs;
summing the filter responses over different orientations; and
normalizing a summation of the thresholded outputs using a summation of a magnitude of the filter response for each of the quadrature filter pairs to obtain the features of interest.

14. The computer-implemented method of claim 13, wherein the predetermined value is a negative number, a positive number, or zero based on application specific characteristics.

15. The computer-implemented method of claim 14, wherein when the features of interest have lower intensities than a background, the predetermined value is a negative number.

16. The computer-implemented method of claim 14, wherein when the features of interest have higher intensities than a background, the predetermined value is a positive number.

17. The computer-implemented method of claim 14, wherein when there is no preference over dark features or bright features, the predetermined value is zero.

18. The computer-implemented method of claim 13, wherein soft thresholding includes estimation of noise characteristics using a high frequency component of the image.
